(19) United States
(12) Patent Application Publication
(10) Pub. No.: US 2005/0166746 A1
(43) Pub. Date: Aug. 4, 2005

(54) Rotary tab cutter

(76) Inventors: Jimmy R. Garrett, Worden, IL (US); Jason R. Garrett, Livingston, IL (US)

Correspondence Address: GRACE J FISHEL, 11970 BORMAN DRIVE, SUITE 220, ST. LOUIS, MO, 63146, US

(21) Appl. No.: 10/770,781

(22) Filed: Feb. 3, 2004

(51) Int. Cl. B31B 1/25

(52) U.S. Cl. 83/885

(57) ABSTRACT

A rotary tab cutter for cutting tabs or the like in a box board blank. The device has a pair of opposing cutters mounted on timed rotating shafts which cooperate to cut the tabs in the nip of the rotating cutters. When a pair of blades are mounted on each of the opposing cutters at an angle to the axis of rotation, the opposing cutters cut a tapered leading edge and a trailing edge on the tab. The shafts may be driven by a drive train including a control device to cut tabs of differing length.

### BACKGROUND OF THE INVENTION

1. Field of the Invention

The present invention relates to a rotary cutter for cutting glue tabs on box blanks.

2. Brief Description of the Prior Art

In a machine for producing folded carton blanks from sheets of corrugated paperboard, the sheets are flexographically printed, creased, slotted, tab cut, glued and folded. The slotting and tab cutting is typically done in a slotter section by performing the slotting operation on the container blank and at the same time making transverse cuts at the ends of the tab using cross-cut knives which cut against an anvil. One example of a cross-cut knife tab cutter is described in U.S. Pat. No. 5,386,753 to Baron et al. and assigned to Ward Holding Company, Inc.

Cross-cut knives do not always make a clean cut so that scrap pieces may remain connected to the cut-out container blank. In addition, it is necessary to periodically adjust the depth of cut of the cross-cut knife due to anvil wear or because of changes in board thickness. Shutting a flexo machine down for maintenance is very expensive in terms of lost throughput.

A dual rotating blade cutter for cutting paperboard into sheets is described in U.S. Pat. No. 6,142,048 to Bradatsch et al. and assigned to GHS Corrugated Machinen und Anlagenbau GmbH. The cutter described in this patent uses two direct drive motors for operating two knives that mesh together to make a cross cut. The rotating blades have intermeshed gear pairs to ensure that the cutter bars rotate in proper synchronization. No provision is made for making cuts at opposing angles such as needed on a glue tab.

### BRIEF SUMMARY OF THE INVENTION

In view of the above, it is an object of the present invention to provide a device for cutting glue tabs and similar elements on a box blank. It is another object to provide a device that is compact and uses a minimum number of parts to produce a precise, controlled cut of glue tabs or the like. It is also an object to provide a device for cutting glue tabs that can be retrofit to any flexo machine. Other objects and features of the invention will be in part apparent and in part pointed out hereinafter.

In accordance with the invention, a device for cutting sheet stock comprising a housing with a pair of shafts mounted therein. The shafts have rotating cutters mounted thereon with blades in opposition to cooperate to cut the sheet stock passing through the nip of the cutters. The shafts have a drive train connected to a motor to rotationally drive the shafts, the motor being responsive to a control device to incrementally rotate the cutters. A tapered cut is formed when the blades on the cutters make an angle to the axis of rotation of the shafts.

The invention summarized above comprises the constructions hereinafter described, the scope of the invention being indicated by the subjoined claims.

### BRIEF DESCRIPTION OF THE SEVERAL VIEWS OF THE DRAWING

In the accompanying drawings, in which one of various possible embodiments of the invention is illustrated, corresponding reference characters refer to corresponding parts throughout the several views of the drawings in which:

FIG. 1 is a perspective view a rotary tab cutter in accordance with the present invention with an attached motor and controller;

FIG. 2 is an exploded perspective view of the rotary tab cutter;

FIG. 3 is an exploded perspective view of a drive train for the rotary tab cutter;

FIG. 4 is a partial cross-section view of the drive train taken along the plane 4-4 in FIG. 2;

FIGS. 5A-5D is a schematic side view showing a leading and trailing edge of a glue tab being cut away from a box blank by the rotary tab cutter of the present invention;

FIG. 6 is a schematic top plan view of a box blank as it may exit from a conventional slotter-creaser (not shown);

FIG. 7 is a schematic top plan view of the box blank of FIG. 6 with a leading edge of the glue tab trimmed by the rotary tab cutter of the present invention; and,

FIG. 8 is a schematic top plan view of the box blank of FIGS. 6 and 7 with a trailing edge of the glue tab trimmed by the rotary tab cutter of the present invention.

### DETAILED DESCRIPTION OF THE INVENTION

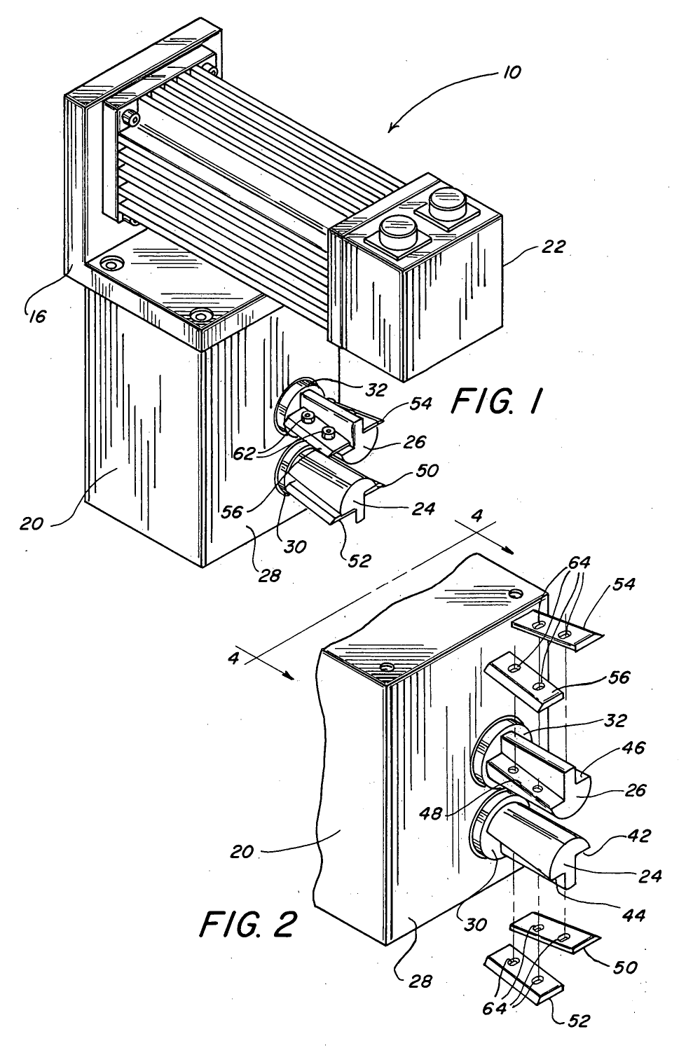

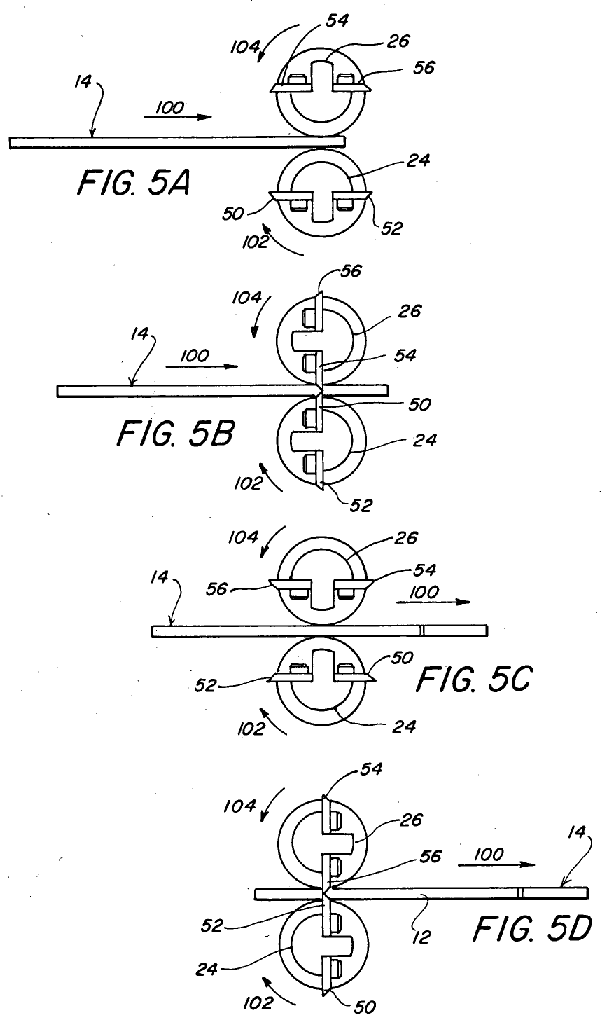

Referring to FIGS. 1-2 more particularly by reference character, reference numeral 10 refers to a rotary tab cutter in accordance with the present invention for cutting a glue tab 12 in a box blank 14 as shown in FIGS. 5A-5D and FIGS. 6-8. As shown, a support bracket 16 mounts a servo motor 18 to a housing 20 of rotary tab cutter 10. A control device 22 is mounted on one end of servo motor 18. A set of shearing cutters 24, 26 is mounted in a front wall 28 of housing 20. Shearing cutters 24, 26 are mounted on a proximal end 30, 32 of shafts 34, 36, respectively. Shafts 34, 36 are journaled for rotation in bores 38, 40, respectively, in front wall 28 of housing 20.

With continuing reference to FIGS. 1-2, shearing cutter 24 has platforms 42, 44 which mount leading blade 50 and trailing blade 52, respectively. Platforms 46, 48 mount leading blade 54 and trailing blade 56, respectively, of shearing cutter 26. Platforms 42, 44 are sloped at angles which are inclined to the axis of shaft 34. Similarly, platforms 46, 48 which mount leading blade 54 and trailing blade 56 of shearing cutter 26 are inclined to the axis of shaft 36.

Angled mounting of blades 50, 52 and blades 54, 56 permits leading blades 50 and 54 to cooperate to cut a leading edge 58 of glue tab 12 with a taper as shown in FIG. 7. Similarly, the angled mounting permits trailing blades 52 and 56 to cooperate to cut a trailing edge 60 of glue tab 12 with a taper as shown in FIG. 8.

Blades 50, 52 are fastened to platforms 42, 44 and blades 54, 56 are fastened to platforms 46, 48, respectively, by suitable fasteners such as screws or bolts 62. Fasteners 62 pass through holes 64 in blades 50, 52, 54 and 56 and mount the blades at complementary angles which are inclined to the plane of box blank 14 at the moment of cutting glue tab 12. Leading blades 50 and 54 thus cooperate to produce a scissors shearing cut of leading edge 58 of glue tab 12. Trailing blades 52 and 56 cooperate to produce a scissors shearing cut of trailing edge 60 of glue tab 12. The scissors shearing action of blades 50, 54 and 52, 56 acts both along the plane of box blank 14 and through the plane of box blank 14 in a manner which requires less power than a cut which acts uniformly into the plane of box blank 14.

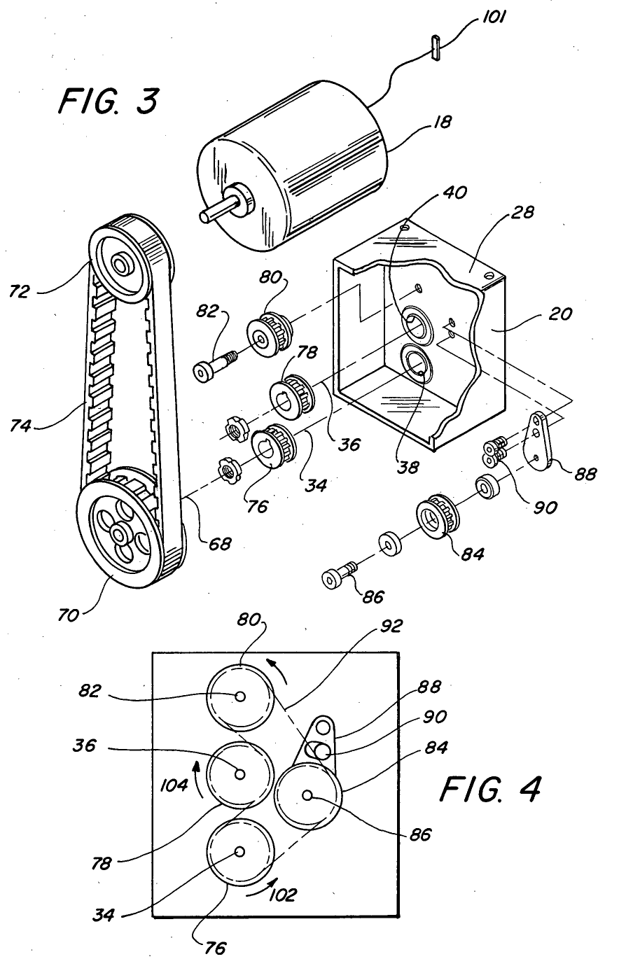

Referring to FIGS. 3-4, a drive mechanism for shearing cutters 24, 26 is shown. In FIG. 3, shaft 36 of shearing cutter 26 is shown in schematic by its axis. Similarly, shaft 34 of shearing cutter 24 is shown in schematic by its axis. A distal end 68 of shaft 34 has a synchronous drive pulley 70, such as a gearbelt pulley, mounted thereon. Drive pulley 70 is driven by synchronous motor pulley 72 attached to servo motor 18. Motor pulley 72 and drive pulley 70 are connected by a synchronous drive belt 74 such as a gearbelt.

Shaft 34 has a timing pulley 76 fixed thereon, by a keyed attachment for example. Timing pulley 76 is intermediate distal end 68 and proximal end 30 of shaft 34. Shaft 36 has a timing pulley 78 fixed thereon, also by a suitable attachment structure.

Front wall 28 of housing 20 has an idler pulley 80 mounted on a stub shaft 82 as shown. Housing 20 also has a tensioning pulley 84 mounted thereon. Tensioning pulley 84 may be mounted on a stub shaft 86 which is connected to a tensioning lever 88. Tensioning lever 88 may be fixed in place by a locking bolt 90, as shown. Idler pulley 80 and tensioning pulley 84 are preferably synchronous with timing pulleys 76 and 78. Pulleys 76, 78, 80 and 84 are preferably in the same vertical plane, or substantially so, and are connecting by a timing belt 92 as shown in FIG. 4. Timing belt 92 may be a gearbelt to cooperate with pulleys 76, 78, 80 and 84. Timing pulleys 76 and 78 are of the same diameter to drive shearing cutters 24 and 26 at the same rotational speed and to maintain leading blades 50, 54 and trailing blades 52, 56 in proper register.

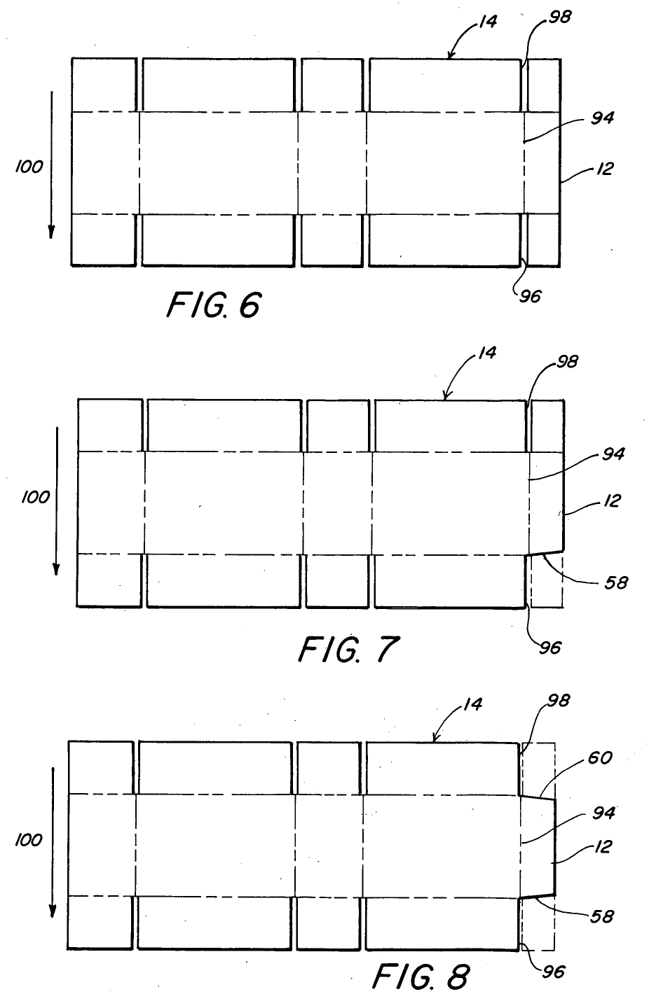

Turning to FIGS. 6-8 in combination with FIGS. 5A-5D, box blank 14 is shown in FIG. 6 in the form it exits from a conventional slotter section of a flexo machine for producing folded carton blanks. Box blank 14 has the appropriate slots and fold locating creases, including glue tab crease 94 and glue tab width defining slots 96, 98. At this time, shearing cutters 24, 26 are in null or beginning position as shown in FIG. 5A. Arrow 100 indicates the direction of travel through rotary tab cutter 10 as described further herein.

FIG. 7 shows box blank 14 after shearing cutters 24, 26 have cut leading edge 58 of glue tab 12. This is accomplished by rotating shearing cutters 180 degrees into the position shown in FIG. 5C, providing scissor shearing action as they pass through the position shown in FIG. 5B and forming the tapered cut of leading edge 58. As the box blank moves further through rotary tab cutter 10, shearing cutters 24, 26 cut trailing edge 60 of glue tab 12 as shown in FIG. 8. As this occurs, rotating shearing cutters rotate 180 degrees back into null or starting position shown in FIG. 5A, providing scissor shearing action as they pass through the position shown in FIG. 5D and forming the tapered cut of trailing edge 60.

As will be appreciated rotary tab cutter 10 is provided with conventional rollers and guides to guide box blank 14 through the nip of shearing cutters 24, 26. More particularly, as box blank 14 travels into rotary tab cutter 10, traveling in the direction of arrow 100 in FIGS. 5A-5D and FIGS. 6-8, a sensor 101 locates the leading edge of box blank 14 and sends a signal to control device 22. Control device 22 sends an appropriately timed signal to servo motor 18 and at the appropriate time shearing cutters 24, 26 are rotated from the zero or null position shown in FIG. 5A through 180 degrees to the position shown in FIG. 5C while cutting leading edge 58 of glue tab 12 as shearing cutters 24, 26 pass through the position shown in FIG. 5B. After the appropriate time delay depending on the width of glue tab 12 and the line speed at which box blank 14 passes through rotary tab cutter 10, control device 22 sends a second signal to servo motor 18 and shearing cutters 24, 26 are rotated another 180 degrees back to the null position shown in FIG. 5A while cutting trailing edge 60 of glue tab 12 as shearing cutters 24, 26 pass through the position shown in FIG. 5D. It will be appreciated by those skilled in the art that the sensing and controlling mechanisms may be conventional and can command servo motor 18 to incrementally rotate shearing cutters 24, 26 as described herein.

As shown in FIGS. 1-4, the drive mechanism for rotary tab cutter 10 is very compact. Servo motor 18 drives motor pulley 72 which rotates drive belt 74. Drive belt 74 rotates drive pulley 70 which rotates shaft 34, timing pulley 76 and shearing cutter 24 as shown by arrow 102 in FIGS. 4 and 5A-5D. Timing pulley 76 drives timing belt 92 which counter rotates timing pulley 78 as shown by arrow 104, shaft 36 and shearing cutter 26 in the opposite direction.

A shown in the drawings, platforms 42, 44 and platforms 46, 48 are inclined to mount blades 50, 52 and 56, 58, respectively, at an angle with respect to the axis of shafts 34, 36 and the plane of box blank 14. Platforms 42, 46 taper toward the axis of shafts 34, 36 as best seen in FIG. 2 such that leading blades 50, 54 cut an inward taper forming leading edge 58 of glue tab 12 as shown in FIG. 7. Platforms 44, 48 taper away from the axis of shafts 34, 36 such that trailing blades 52, 56 cut an outward taper forming trailing edge 60 of glue tab 12 as shown in FIG. 8. As thus cut, glue tab 12 has edges 58 and 60 which have a converging taper in the direction of the terminal edge of glue tab 12.

It will be appreciated by those skilled in the art that a variety of modifications may be made in the embodiments disclosed without departing from the spirit of the invention. For example, a single pair of shearing cutter blades may be used on shearing cutters 24, 26. If control device 22 directs servo motor 18 to rotate shafts 34, 36 through an angle of 360 degrees at each cut, the single pair of cutter blades may be used to cut both leading edge 58 and trailing edge 60 of glue tab 12. This configuration would be effective but glue tab 12 would not have the taper shown in FIG. 8.

In view of the above, it will be seen that the several objects of the invention are achieved and other advantageous results attained. As various changes could be made in the above constructions without departing from the scope of the invention, it is intended that all matter contained in the above description or shown in the accompanying drawings shall be interpreted as illustrative and not in a limiting sense.

1. A device for cutting sheet stock comprising a frame with a pair of shafts mounted therein, the shafts having shearing cutters mounted at a proximal end of the shafts, the cutters being mounted in opposition to cooperate to cut the sheet stock passing through a nip of the cutters, the shafts connected to a motor through a drive train, the drive train being connected to a motor to rotationally drive the shafts, the motor being responsive to a control device to incrementally rotate the cutters.

2. The device of claim 1 wherein the device is a tab cutter.

3. The device of claim 2 wherein each cutter has a platform for mounting a blade.

4. The device of claim 2 wherein each cutter has a pair of platforms for mounting a leading blade and a trailing blade.

5. The device of claim 4 wherein the platform for mounting the leading blade on each cutter is at an angle tapered toward an axis of the shafts and wherein the platform for mounting the trailing blade on each cutter is at an angle tapered away from the axis of the shafts.

6. The device of claim 5 wherein the drive train has a motor pulley connected to the motor and a drive pulley connected to one of the shafts, said motor pulley and drive pulley being synchronous and connected by a synchronous drive belt.

7. The device of claim 6 wherein the drive train further includes a timing pulley mounted on each shaft, said timing pulleys being connect by a timing belt, said timing pulleys being of the same diameter to drive the cutters at the same rotational speed and to maintain the leading and trailing blades in register.

8. The device of claim 7 wherein the timing belt also passes around an idler pulley and tensioning pulley.

9. The device of claim 8 wherein the timing pulleys, idler pulley and tensioning pulley are generally in the same plane.

10. A device for cutting sheet stock comprising a frame with a pair of shafts mounted therein, the shafts having shearing cutters mounted at a proximal end of the shafts, the cutters being mounted in opposition to cooperate to cut the sheet stock passing through a nip of the cutters, the shafts connected to a motor through a drive train, the drive train being connected to a motor to rotationally drive the shafts, the motor being responsive to a control device to incrementally rotate the cutters, a sensor for detecting a leading edge of the sheet stock and sending a signal to the control device, said control device sending an appropriately timed signal to the motor for rotating the shearing cutters.

11. The device of claim 10 wherein the device is a tab cutter.

12. The device of claim 11 wherein each cutter has a platform for mounting a blade.

13. The device of claim 11 wherein each cutter has a pair of platforms for mounting a leading blade and a trailing blade one hundred and eighty degrees apart.

14. The device of claim 13 wherein the platform for mounting the leading blade on each cutter is at an angle tapered toward an axis of the shafts and wherein the platform for mounting the trailing blade on each cutter is at an angle tapered away from the axis of the shafts.

15. The device of claim 14 wherein the drive train has a motor pulley connected to the motor and a drive pulley connected to one of the shafts, said motor pulley and drive pulley being synchronous and connected by a synchronous drive belt.

16. The device of claim 15 wherein the drive train further includes a timing pulley mounted on each shaft, said timing pulleys being connect by a timing belt, said timing pulleys being of the same diameter to drive the cutters at the same rotational speed and to maintain the leading and trailing blades in register.

17. The device of claim 16 wherein the timing belt also passes around an idler pulley and tensioning pulley.

18. The device of claim 17 wherein the timing pulleys, idler pulley and tensioning pulley are generally in the same plane.

20. A tab cutter for cutting a glue tab on a box blank comprising a frame, the frame having means for mounting a pair of parallel shafts therein, the tab cutter having means for counter-rotating the shafts, the shafts having paired opposed means for cutting the glue tab at the proximal ends thereof, the glue tab being cut by the cutting means in the nip of the cutting means, the cutting means having means for cutting tapered edges on the glue tab including means for cutting a tapered leading edge and a tapered trailing edge on the glue tab with the same pair of opposed cutting means.
